(19) United States
(12) Patent Application Publication
(10) Pub. No.: US 2012/0098749 A1
(43) Pub. Date: Apr. 26, 2012

(54) 3D VIEWING DEVICE PROVIDING ADJUSTMENT IN 3D IMAGE PARAMETERS

(76) Inventors: Hsuan-Ching Liu, Tainan County (TW); Shu-Ming Liu, Tainan County (TW)

(21) Appl. No.: 12/910,839

(22) Filed: Oct. 24, 2010

(51) Int. Cl. G06F 3/02

(52) U.S. Cl. 345/169

(57) ABSTRACT

A 3D viewing device is provided for creating a stereoscopic effect when used in viewing 2D images provided by an image source. When in use by a user during a 3D presentation, the 3D viewing device also provides the viewer with direct control of adjusting 3D image parameters.

### BACKGROUND OF THE INVENTION

1. Field of the Invention

The present invention is related to a 3D viewing device, and more particularly, to a 3D viewing device capable of providing adjustment in 3D image parameters.

2. Description of the Prior Art

Three-dimensional (3D) display technology provides more vivid visual experiences than traditional two-dimensional (2D) display technology. In general, the stereoscopic image processing involves two camera systems in which two different images or videos are taken from slightly different camera angles and locations. The object is to simulate the manner in which depth is perceived by a pair of human eyes, which are themselves slightly offset from each other and thus view images at slightly different angles. The two camera images or videos are superimposed as an integrated stereoscopic image and presented to the viewer simultaneously on a television or movie screen. The two camera images are then separated in some fashion for the viewer so that one eye sees only one image and the other eye sees only the other image. In this way, an illusion of depth is created by simulating normal vision. The visual cortex of the human brain fuses this into perception of a 3D scene or composition.

There are two major types of 3D viewing environments: naked-eye and glasses-type. In the naked-eye 3D viewing environment, stereoscopic images are directly generated using e-holographic, volumetric, multi-planar or multiplexed 2D display devices and can be viewed without additional devices. In the glasses-type viewing environment, 3D viewing devices, such as polarizing glasses, anaglyph glasses, or shutter glasses, are required for creating the illusion of stereoscopic images from planer images.

FIG. 1 is a functional block diagram illustrating a prior art glasses-type 3D display system 100. The 3D display system 100 includes an image source 110, a remote controller 120, and a 3D viewing device 130. The remote controller 120 is a component of an electronics device used for operating the image source 110 wirelessly from a short line-of-sight distance. The remote controller 120 is usually a small wireless battery-based handheld device with an array of buttons for adjusting various settings such as television channel, volume, 2D/3D mode switch and image adjustment. Image adjustment, such as brightness, contrast, sharpness and 3D depth (3D mode only) adjustment, may be performed anytime during a 3D presentation using the remote controller 120. However, the viewer needs to keep the remote controller 120 handy at all times, which may cause inconvenience to the viewer.

### SUMMARY OF THE INVENTION

The present invention provides a 3D viewing device providing adjustment in 3D image parameters The 3D viewing device includes a sensor configured to identify a user command of adjusting a 3D image parameter and generate a control signal according to how the user command is issued; and a transmitter configured to transmit the control signal to an image source of a 3D display system so as to adjust the 3D image parameter according to the user command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a prior art glasses-type 3D display system.

FIG. 2 is a functional block diagram illustrating a glasses-type 3D display system according to the present invention.

FIGS. 3-6 are diagrams illustrating the 3D viewing device according to embodiments of the present invention.

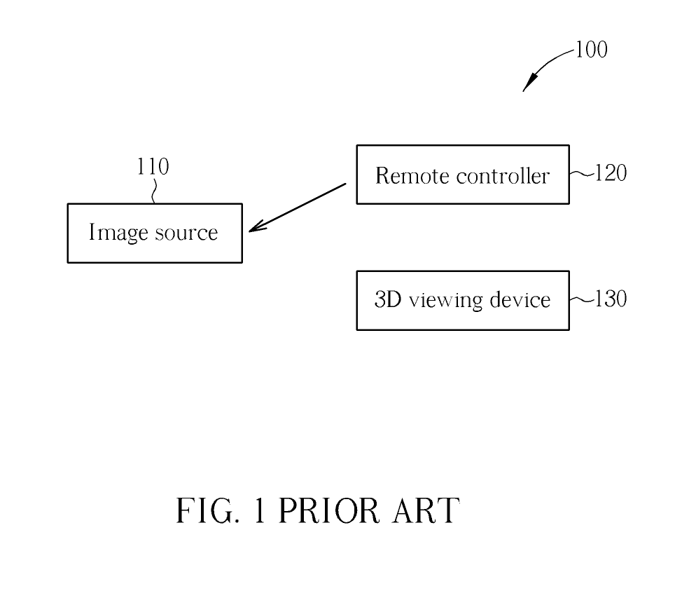

### DETAILED DESCRIPTION

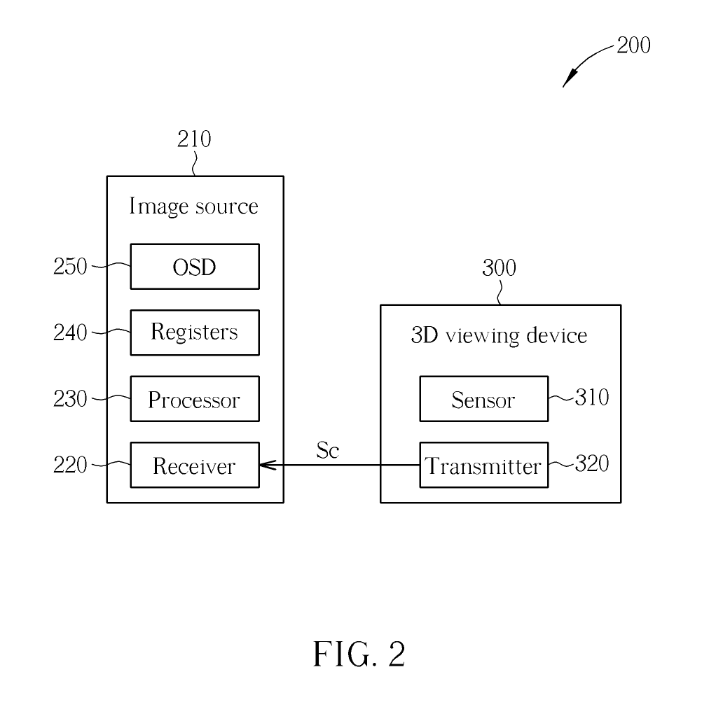

FIG. 2 is a functional block diagram illustrating a glasses-type 3D display system 200 according to the present invention. The 3D display system 200 includes an image source 210 and a 3D viewing device 300. The image source 210, such as a 3D-ready TV set, a computer, a projector, or other equipment capable of providing 2D images for 3D processing, includes a receiver 220, a processor 230, and a plurality of registers 240. The registers 240 are used for storing 3D image parameters, such as 3D depth, contrast, brightness and sharpness, etc. The processor 230 is configured to control the operation of the image source 210 and set the values of the 3D image parameters according to a control signal Sc received by the receiver 220.

According to different 3D image processing techniques, the 3D viewing device 300 may be polarizing glasses, anaglyph glasses, shutter glasses, or other types of 3D glasses capable of creating a stereoscopic effect when used in viewing the 2D images provided by the image source 210. In the present invention, the 3D viewing device 300, including a sensor 310 and a transmitter 320, allows a user command to be issued in different predetermined ways according to how the 3D image parameter adjustment is intended, such as increasing or decreasing the value of 3D depth by various degrees. The sensor 310 is configured to detect the presence of the user command and generate the control signal Sc according to how the user command is issued. In other words, the sensor 310 may determine whether an increase or decrease in a certain 3D image parameter is demanded by the viewer and inform the processor 230 to make corresponding 3D image parameter adjustment.

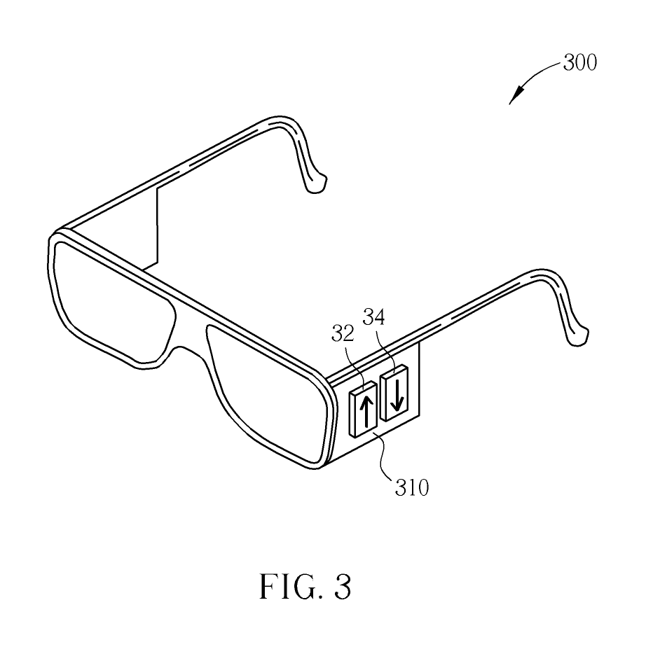

FIG. 3 is a diagram illustrating the 3D viewing device 300 according to a first embodiment of the present invention. In this embodiment, the sensor 310 is a resistive-type sensor having a variable resistor whose value may be varied by pressing two hot keys 32 and 34. The sensor 310 may thus be configured to detect the resistance variation which is induced as the user command is applied to the hot key 32 or 34, thereby outputting the control signal Sc according to the amount of resistance variation. For example, when the viewer issues the user command of increasing 3D depth by pressing the hot key 32, the sensor 310 is able to detect an increase (or decrease) in the measured resistance and generate the control signal Sc according to the amount of resistance variation; when the viewer issues the user command of decreasing 3D depth by pressing the hot key 34, the sensor 310 is able to detect an decrease (or increase) in the measured resistance and generate the control signal Sc according to the amount of resistance variation. The resistance variation detected by the sensor 310 is associated with how many times each hot key has been pressed, which also indicates the amount of 3D depth adjustment demanded by the viewer. Upon receiving the control signal Sc from the transmitter 320, the processor 230 may update the registers 240 for setting 3D depth to the value indicated by the control signal Sc.

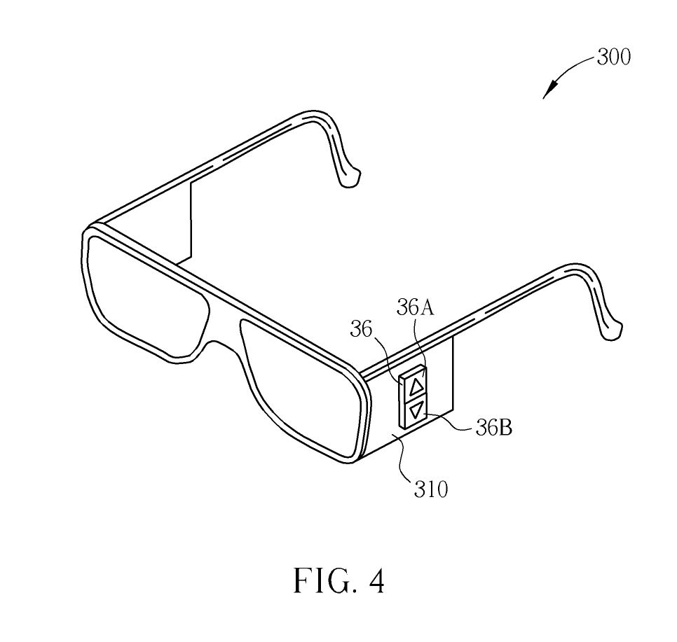

FIG. 4 is a diagram illustrating the 3D viewing device 300 according to a second embodiment of the present invention. In this embodiment, the sensor 310 is a resistive-type sensor having a variable resistor whose value may be varied by pressing a directional pad 36 on two input ends 36A and 36B. The sensor 310 may thus be configured to detect the resistance variation which is induced as the user command is applied to the input end 36A or 36B, thereby outputting the control signal Sc according to the amount of resistance variation. For example, when the viewer issues the user command of increasing 3D depth by pressing the input end 36A of the directional pad 36, the sensor 310 is able to detect an increase (or decrease) in the measured resistance and generate the control signal Sc according to the amount of resistance variation; when the viewer issues the user command of decreasing 3D depth by pressing the input end 36B of the directional pad 36, the sensor 310 is able to detect an decrease (or increase) in the measured resistance and generate the control signal Sc according to the amount of resistance variation. The resistance variation detected by the sensor 310 is associated with how many times each input end has been pressed, which also indicates the amount of 3D depth adjustment demanded by the viewer. Upon receiving the control signal Sc from the transmitter 320, the processor 230 may update the registers 240 for setting 3D depth to the value indicated by the control signal Sc.

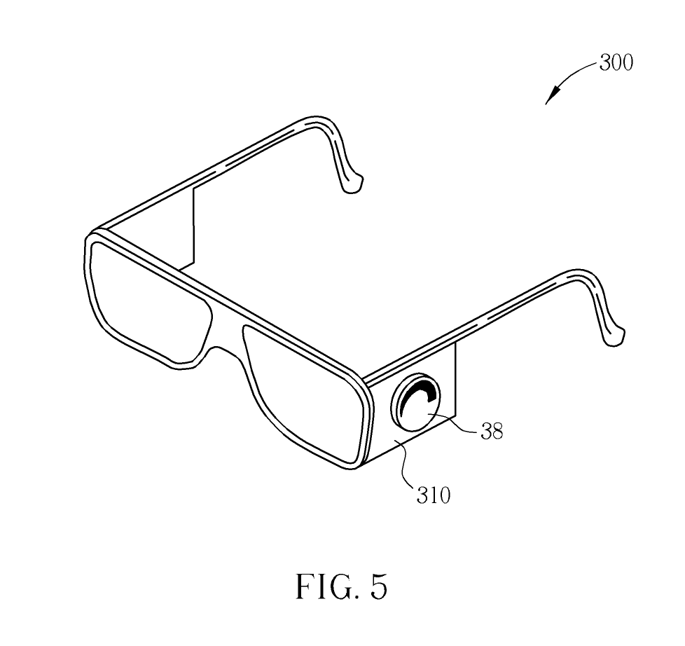

FIG. 5 is a diagram illustrating the 3D viewing device 300 according to a third embodiment of the present invention. In this embodiment, the sensor 310 is a resistive-type sensor having a variable resistor whose value may be varied by spinning a rotary button 38. The sensor 310 may thus be configured to detect the resistance variation which is induced as the user command is applied to spin the rotary button 38, thereby outputting the control signal Sc according to the amount of resistance variation. For example, when the viewer issues the user command of increasing 3D depth by spinning the rotary button 38 clockwise, the sensor 310 is able to detect an increase (or decrease) in the measured resistance and generate the control signal Sc according to the amount of resistance variation; when the viewer issues the user command of decreasing 3D depth by spinning the rotary button 38 counterclockwise, the sensor 310 is able to detect an decrease (or increase) in the measured resistance and generate the control signal Sc according to the amount of resistance variation. The resistance variation detected by the sensor 310 is associated with the spin direction and the amount of rotation of the rotary button 38, which also indicates the amount of 3D depth adjustment demanded by the viewer. Upon receiving the control signal Sc from the transmitter 320, the processor 230 may update the registers 240 for setting 3D depth to the value indicated by the control signal Sc.

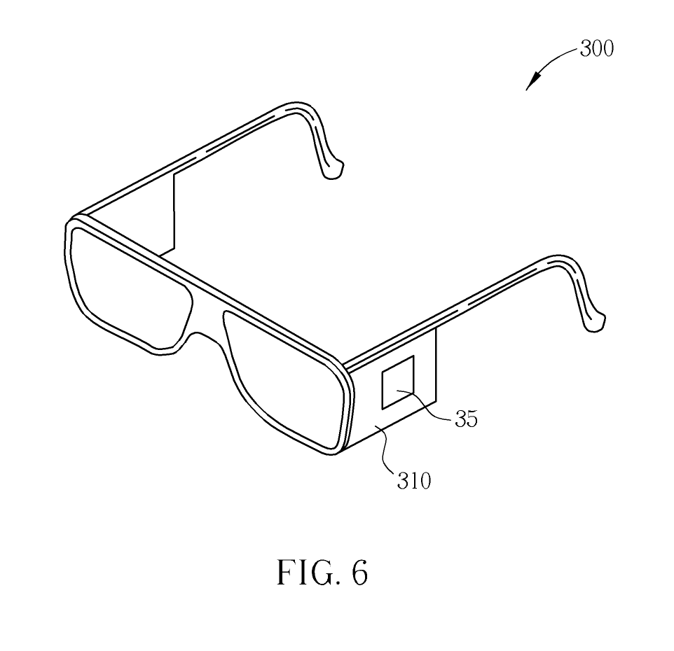

FIG. 6 is a diagram illustrating the 3D viewing device 300 according to a fourth embodiment of the present invention. In this embodiment, the sensor 310 is an optical sensor configured to detect a two-dimensional motion when the user command is issued within its sensing range. Similar to the operation of an optical mouse well-known to those skilled in the art, the sensor 310 may include a light source 35 (such as a light-emitting diode or a photodiode) and is able to identify the directionality of the user command when it is issued within the sensing range and thus interfere the original light pattern of the light source 35 in a specific manner, thereby generating the control signal Sc accordingly. For example, the viewer may issue the user command of increasing 3D depth by swinging his finger within the sensing range of the sensor 310 in the forward direction, or the user command of decreasing 3D depth by swinging his finger within the sensing range of the sensor 310 in the backward direction. Based on the variations in light pattern, the sensor 310 may determine how many times the user has swung his finger in a certain direction, which also indicates the amount of 3D depth adjustment demanded by the viewer. Upon receiving the control signal Sc from the transmitter 320, the processor 230 may update the registers 240 for setting 3D depth to the value indicated by the control signal Sc.

In the present invention, the image source 210 may also present an OSD (on-screen display) 250 on its screen so as to inform the viewer about the current value of a certain 3D image parameter after adjustment. The receiver 220 and the transmitter 320 may communicate with each other via infrared (IR) signals or radio signals. The shape of the 3D viewing device 300 and the location of the sensor 310 may differ in other applications. The embodiments depicted in FIGS. 4-6 are merely for illustrative purpose, and do not limit the scope of the present invention.

The present invention allows the viewer to adjust 3D image parameters (such as 3D depth) of the image source 210 using the 3D viewing device 230. As an essential device in the glasses-type 3D display system 200, the viewer needs to wear the 3D viewing device 230 during the entire 3D presentation. The present invention can thus provide a more convenient 3D viewing environment in which the adjustment of 3D image parameters can be performed directly using the 3D viewing device 230 instead of an additional remote controller which might not always be handy.

Those skilled in the art will readily observe that numerous modifications and alterations of the device and method may be made while retaining the teachings of the invention.

What is claimed is:

1. A three-dimensional (3D) viewing device providing adjustment in 3D image parameters, comprising:
a sensor configured to identify a user command of adjusting a 3D image parameter and generate a control signal according to how the user command is issued; and
a transmitter configured to transmit the control signal to an image source of a 3D display system so as to adjust the 3D image parameter according to the user command.

2. The 3D viewing device of claim 1, wherein the sensor is further configured to detect a resistance variation induced by the user command and generate the control signal according an amount of resistance variation.

3. The 3D viewing device of claim 2 further comprising a first hot key for generating a positive resistance variation upon receiving the user command and a second hot key for generating a negative resistance variation upon receiving the user command.

4. The 3D viewing device of claim 2 further comprising a directional pad having a first button for generating a positive resistance variation upon receiving the user command and a second button for generating a negative resistance variation upon receiving the user command.

5. The 3D viewing device of claim 2 further comprising a rotary button for generating a positive resistance variation when spinning in a first direction in response to the user command or for generating a negative resistance variation when spinning in a second direction opposite to the first direction in response to the user command.

6. The 3D viewing device of claim 1, wherein the sensor is further configured to detect a two-dimensional motion of the user command by measuring a variation in a light pattern which is induced when the user command is issued within a sensing range of the sensor.

7. The 3D viewing device of claim 6 further comprising a light source for providing the light pattern.
